(19) United States
(12) Patent Application Publication
(10) Pub. No.: US 2025/0268422 A1
(43) Pub. Date: Aug. 28, 2025

(54) SMOKELESS BARBECUE SYSTEM

(71) Applicant: Xuan Linh DAM, München (DE)

(72) Inventor: Xuan Linh DAM, München (DE)

(21) Appl. No.: 18/858,634

(22) PCT Filed: Apr. 21, 2023
(86) PCT No.: PCT/EP2023/060501

§ 371 Date: Oct. 21, 2024

(30) Foreign Application Priority Data
Apr. 23, 2022 (EP) 22169604.0
Nov. 25, 2022 (EP) 22209695.0

(51) Int. Cl. A47J 37/07

(52) U.S. Cl. CPC A47J 37/0709; A47J 37/0713; A47J 37/0786

(57) ABSTRACT

A cooking appliance comprising a casing having an upper opening. The cooking appliance further comprises a grill grid arranged in said upper opening of said casing, and a heating assembly comprising at least one heating element arranged within said casing, said heating element being connectable to an energy source. Further, the cooking appliance comprises a cooling system connected to said grill grid for cooling said grill grid.

### CROSS-REFERENCE TO RELATED APPLICATIONS

The present application is a U.S. National Stage Application of International Application No. PCT/EP2023/060501 filed on Apr. 21, 2023, published on Oct. 26, 2023 as WO2023/203222 A1, and entitled SMOKELESS BARBECUE SYSTEM, which claims the benefit and priority of both European Patent Application No. 22169604.0, filed on Apr. 23, 2022, and European Patent Application No. 22209695.0, filed on Nov. 25, 2022, each of which is incorporated herein by reference in its entirety for any purpose whatsoever.

### FIELD OF THE DISCLOSURE

The present disclosure concerns a cooking appliance which is primarily employed as a Smokeless Barbecue System. The present disclosure relates to the primary use of cooking grills. It is particularly concerned with avoiding smokes during the barbecue process, maximum flexibility in applying different types of energy sources, and diversified mobility of the cooking appliance. Secondary uses of this disclosure are hot pot cooking or pan-frying.

### BACKGROUND

Cooking grills of various types currently available in the market are either smoking or not optimized for indoor use. Depending on the types of energy sources utilized, exhaust gases, such as carbon monoxide (CO), cause huge technical, financial, and governmental hurdles for users to obtain the permission to use those cooking grills indoors. Those hurdles are even more serious if the grills generate smokes. Furthermore, existing cooking grills are restricted either to indoor or outdoor use only.

### SUMMARY

The object of the present disclosure provides a cooking appliance, especially a barbecue grill, which overcomes the problems and disadvantages of prior art grills described above.

The cooking appliance of the present disclosure is defined in the appended claims.

Accordingly, the present disclosure concerns a cooking appliance comprising
a casing having an upper opening;
a grill grid arranged in said upper opening of said casing;
a heating assembly comprising at least one heating element arranged within said casing, said heating element being connectable to an energy source; and
a cooling system for cooling said grill grid.

In certain embodiments, the cooling system is an external cooling system connected to said grill grid. In other embodiments, said cooling system is an integral part of said grill grid.

In certain embodiments said heating assembly comprises two heating elements arranged laterally beneath said grill grid.

In certain embodiments said heating elements comprise electric heaters connectable to a re-chargeable battery housed within said casing and/or to an external power grid.

In this case said electric heaters can comprise fiber carbon heaters.

In certain embodiments said heating elements comprise gas heaters connectable to a gas supply, said gas supply being selected from a built-in gas cartridge removable housed within said casing, an external gas tank or to fixedly installed gas line.

In certain embodiments said grill grid comprises a hollow tube assembly connectable to a cooling system comprising a source of cooling fluid.

Said hollow tube assembly can comprise essentially parallel hollow tubes extending between a first water tank arranged on one side said grill grid and a second water tank arranged on an opposite side of said grill grid. The water tanks can be an integral part of the grill grid thus defining an internal cooling system.

Particularly, said hollow tube assembly can comprise a meandering hollow tube.

Said source of cooling fluid can comprise a water battery or water storage arranged in a cooling circuit. In this case said cooling circuit can comprise a radiator.

In certain embodiments, said water battery or water storage is pressurizable.

In certain embodiments said cooling circuit can comprise a feed pump selected from electric pumps or hydraulic pumps, especially hydraulic RAM-pumps or hydraulic pumps operated by pressurized air.

Said essentially parallel hollow tubes can be configured as first tubes which rise from said first (or bottom) water tank to said second (or top) water tank, and at least two second tubes extend horizontally between said first (or bottom) water tank and said second (or top) water tank.

Preferably, said first tubes have a smaller inner diameter than said second tubes.

In certain embodiments said first tubes can comprise grease stoppers at their outer circumference.

In certain embodiments, a grease stopper can alternatively or additionally be arranged at a bottom edge of said first (or bottom) water tank.

In certain embodiments said first and second tanks comprise steam outlets.

Said steam outlets can comprise steam tubes, said steam tubes being connected to downwardly extending steam ductings.

The cooking appliance of the present disclosure can further comprising a water tray arranged beneath said grill grid within said casing.

In certain embodiments of the cooking appliance of the present disclosure, said grill grid is removable.

The present disclosure also concerns a set comprising the cooking appliance with removable grill grid as defined above, a hot pot holder, and a pan tray, wherein said grill grid, said hot pot holder and said pan tray are exchangeably arrangeable in said upper opening of said casing.

This disclosure of cooking appliance is primarily employed as a smokeless barbecue system. The smokeless barbecue system consists of three major modules:
Two grill burners each placed sidewise below the grill grid providing heat for cooking;
Grill grid supporting the barbecue food, whereas the barbecue food area of the grill grid does not overlap with the grill burners
A passive or preferably active cooling system to cool down the grill grid and thus to prevent barbecue food from burning and from smoking. Passive cooling is achieved by omitting the active cooling system, and by using a grill grid with self-sufficient passive cooling capability.

Grill burner, grill grid, and active cooling system can be configured in many ways, allowing maximum freedom of mobility and of utilization of energy sources. The configurations provided in this document only describe the preferred ones, whereas other configurations can be composed based on the general nature of the components outlined within the present document.

Instead of using the grill grid, a hot pot holder or a pan can be put in place of the grill grid to convert the smokeless barbecue system into either a hot pot cooking system or a pan-frying system. These two additional applications are of secondary nature of this smokeless barbecue system.

This smokeless barbecue system is designed such that it can be put on a table or be integrated into a table-top.

The present disclosure achieves the following objectives:

### Real Smokeless and Healthy Barbecue Experience:

Conventional barbecue grills produce smokes from burning food, containing polycyclic aromatic hydrocarbons (PAH), which is carcinogenic in nature. This disclosure features a real smoke-free capability, regardless of the configurations of the major modules. Moreover, this smokeless and gentle way of barbecue does not disproportionately dehydrate the food and preserves its nutrients.

### Application of Various Forms of Energy:

The present disclosure employs both fossil energy carriers and energy carriers converted from renewable energy. Furthermore, electrical energy can be used as heat source.

In addition to charcoal, natural gas (NG), liquefied petroleum gas (LPG), and gas from cartridges, being the current common sources of fossil energy, this disclosure also consider hydrogen (green/blue) being the future energy carrier converted from renewable energy. Gas cartridges can be filled with butane & propane or hydrogen. These fossil energy carriers and hydrogen produce carbon monoxide (CO), whereas the utilization of electrical energy is free of CO, making it the preferred energy option for indoor application of the smokeless barbecue system.

### Flexible Mobility:

This disclosure allows barbecue grill to be used outdoors or indoors, and depending on the configurations applied, the barbecue grill can versatility be used both outdoors and indoors. However, to achieve maximum indoor and outdoor mobility, the most preferred configurations of the smokeless barbecue system are:
Passive cooling of grill grid combined with gas cartridge or gas cylinder.
Active cooling of grill grid with air compressor combined with gas cartridge or gas cylinder.
Active cooling of grill grid with hydraulic ram pump combined with gas cartridge or gas cylinder.
Self-sufficient cooling of grill grid without requiring external power sources by using a self-circulating water-cooled grill grid combined with gas cartridge or gas cylinder.

Use smokeless barbecue system appropriate for indoors allows year-round barbecue experiences:

Barbecue normally is constrained to good weather conditions outdoors. This is especially true for regions with four seasons climate or in colder area of the globe. Thus, the barbecue season is normally limited to certain months of the year. Particular configurations of the smokeless barbecue system enable barbecue even during raining, cold or snowing seasons indoors. For configurations featuring both outdoor and indoor capabilities, the smokeless barbecue system can be employed outdoors during good weather season, and indoors during cold or snowing weather period of the year. This would make a perfect Christmas barbecue event with family and friends.

Reduce total costs of safety infrastructure, and ease of obtaining permission to operate indoors, especially for indoor gastronomic facilities:

For employment of a single grill indoors, governmental safety requirements, costs for installation, and the total cost of ownership are easily manageable. However, if dozens of grills are utilized indoors of a gastronomic facility, the efforts and costs for technical safety infrastructure become greatly challenging for any business owner—even if smokeless grills are utilized. As soon as fossil energy, and toxic emission gases, such as carbon monoxide (CO) are involved in the barbecue process, very strict safety regulations must be complied to obtain operation permission from local government. Employment of conventional, smoked grills becomes even too expensive for business owner to provide indoor barbecue to their customers. In certain buildings, such as shopping malls, or in certain cities, it is even prohibited to utilize fossil energy indoors for barbecue grills.

Owners of gastronomic facilities can easily avoid huge, technical costs for complying these governmental safety requirements with the following preferred configurations of the smokeless barbecue system:
Passive cooling of grill grid combined with electric grill burner.
Active cooling of grill grid with air compressor combined with electric grill burner.
Active cooling of grill grid with hydraulic ram pump combined with electric grill burner.
Self-sufficient cooling of grill grid without requiring external power sources by using a self-circulating water-cooled grill grid combined with electric burner.

### Sustainable, Environmentally Friendly Barbecue Grills:

First, smokeless grill process of the smokeless barbecue system does not contaminate the environment with unhealthy smokes.

Second, eliminating resources for safety infrastructure required to install fossil energy supply, to exhaust smokes and toxic emission gases, as such, already contributes to eco-friendliness. Furthermore, it also means that no energy is required to operate the safety infrastructure, resulting in energy saving and an additional contribution to eco-friendliness.

### Use Smokeless Barbecue System as a Hot Pot or Pan-Frying Cooking Appliance:

Beside indoor barbecue, hot pot cooking has become ubiquitous around the globe. Private households and gastronomic businesses usually invest in two different cooking appliances for both applications.

Instead of using the grill grid, a hot pot holder can be put in place of the grill grid to convert the smokeless barbecue system into a hot pot cooking system.

Likewise, the smokeless barbecue system can easily be transformed into a pan-frying system by using a pan instead of the grill grid.

Users just need to invest in one smokeless barbecue system for three different applications: barbecue, hot pot, and pan-frying.

The disclosure will now be described in more detail in connection with preferred embodiments depicted in the attached drawings.

### BRIEF DESCRIPTION OF THE DRAWINGS

FIG. 1 shows a perspective view of a smokeless barbecue system in accordance with one embodiment of the present disclosure;

FIG. 2 shows a section view along line II-II of FIG. 1;

FIG. 3 shows a variant of the barbecue system of FIG. 1 in a hot pot application;

FIG. 4 shows a variant of the barbecue system of FIG. 1 in a pan-fry application;

FIG. 5 shows an embodiment of a passively cooled grill grid according to one embodiment of the present disclosure;

FIG. 6 shows a section view of the embodiment of FIG. 5 according to line VI-VI of FIG. 5;

FIG. 7 shows a water battery for the grill grid of FIG. 5;

FIG. 8 shows an alternative water battery for the grill grid of FIG. 5;

FIG. 9 shows an alternative grill grid with connections to an active cooling system;

FIG. 10 shows yet another alternative grill grid with connections to an active cooling system;

FIG. 11 shows a section view of the grill grid of FIG. 10 according to line XI-XI of FIG. 10;

FIG. 12 shows a first embodiment of an active cooling system with hydraulic pump and fan for a grill grid in accordance with the present disclosure;

FIG. 13 shows another embodiment of an active cooling system with hydraulic pump, without fan and with cooling tub for a water container for a grill grid according to the present disclosure;

FIG. 14 shows yet another embodiment of an active cooling system for a grill grid according to the present disclosure with hydraulic pump, without fan, with cooling tub for radiator and for water container;

FIG. 15 shows a further embodiment of an active cooling system for a grill grid according to the present disclosure operated by air pressure and provided with a fan;

FIG. 16 shows a similar embodiment as the active cooling system of FIG. 15 but without fan;

FIG. 17 shows yet another variant of the active cooling system of FIG. 15 with a cooling tub for radiators;

FIG. 18 shows yet another variant of the active cooling system of FIG. 15 with Air Pressure, with cooling tub for radiators and for water containers;

FIG. 19 shows yet another variant of the active cooling system of FIG. 15 with air pressure, with cooling tub for water containers, with radiators;

FIG. 20 shows yet another variant of the active cooling system of FIG. 15 with air pressure, with cooling tub for water containers, without radiators;

FIG. 21 shows a smokeless barbecue system in accordance with yet another embodiment of the present disclosure using a self-circulating gravity grill grid;

FIG. 22 shows a sectional view of the gravity grill grid according to line XXII-XXII of FIG. 21;

FIG. 23 shows a similar section view as FIG. 22 but including steam tubes and steam ducting;

FIG. 24 shows a further embodiment of the present disclosure using a self-circulating gravity grill grid;

FIG. 25 shows a side view of the self-circulating gravity grill grid of FIG. 24 having a level indicator window;

FIG. 26 shows a sectional side view of the self-circulating gravity grill grid of FIG. 24 along line XXVI-XXVI;

FIG. 27 shows a smokeless barbecue system in accordance with yet another embodiment of the present disclosure using the self-circulating gravity grill grid of FIGS. 24 to 26 in a view similar to the embodiment of FIG. 23 showing steam tubes, steam ducting, and a grease stopper edge below the bottom water tank; and

FIG. 28 shows a perspective view of still another embodiment of a smokeless barbecue system in accordance with the present disclosure having a refill system for the water tray in a similar view as the embodiment of FIG. 1.

### DETAILED DESCRIPTION

Throughout the drawings, identical or similar elements or elements having similar functionalities are denoted by the same reference signs.

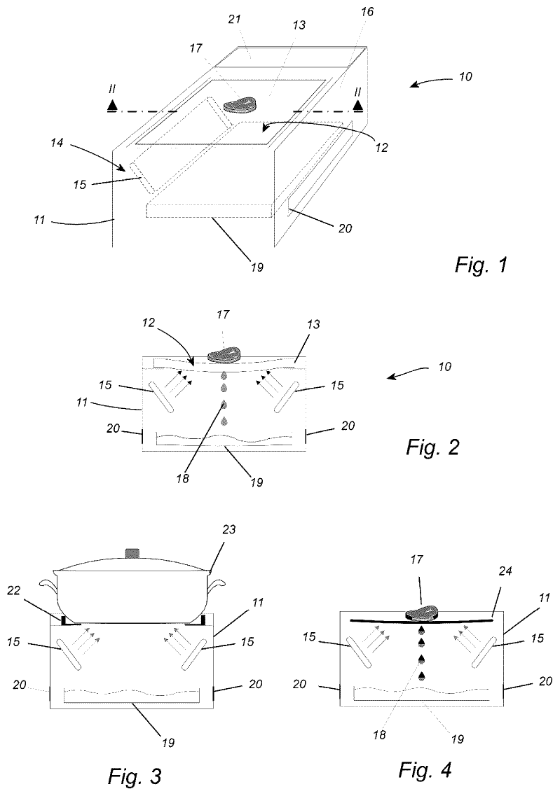

FIGS. 1 and 2 show a perspective view of a cooking appliance 10 functioning as a smokeless barbecue system in accordance with one embodiment of the present disclosure. The cooking appliance 10 comprises a casing 11 having an upper opening 12.

A grill grid 13 is arranged in said upper opening 12 of said casing 11. A heating assembly 14 comprising two heating elements 15 is arranged within said casing 11, said heating elements being connectable to an energy source not depicted in the drawings. A cooling system 16 is connected to the grill grid 13 for cooling said grill grid 13. The perspective drawing in FIG. 1 and the cross section in FIG. 2 illustrate the basic function of the smokeless barbecue system 10. Two grill burners 15 generate heat for the food 17 placed on the grill grid 13 to be barbecued. The passive or active cooling system 16 circulate water inside the grill grid 13 to cool it down (different types of active cooling system are described below).

Smokelessness Mainly Derives from Two Technical Implementations:

First, two grill burners 15 each are placed sidewise below the grill grid 13, whereas the grill area of the grill grid 13 does not overlap the grill burners 15. Food residues/grease 18 dropping down from the grill grid 13 don't get burnt and smoked by the grill burners 15 but fall into a water tray 19. To direct food residues/grease 18 to fall more towards the center of the water tray 19, instead of splashing towards the rims of the grill grid 13, the grill grid 13 has symmetric downward slopes from two rims of the grill grid 13, forming a V-shape, as can best be seen in the section view of FIG. 2.

Second, the grill grid 13 is cooled below burning temperature of the food 17 so that no smoke is generated.

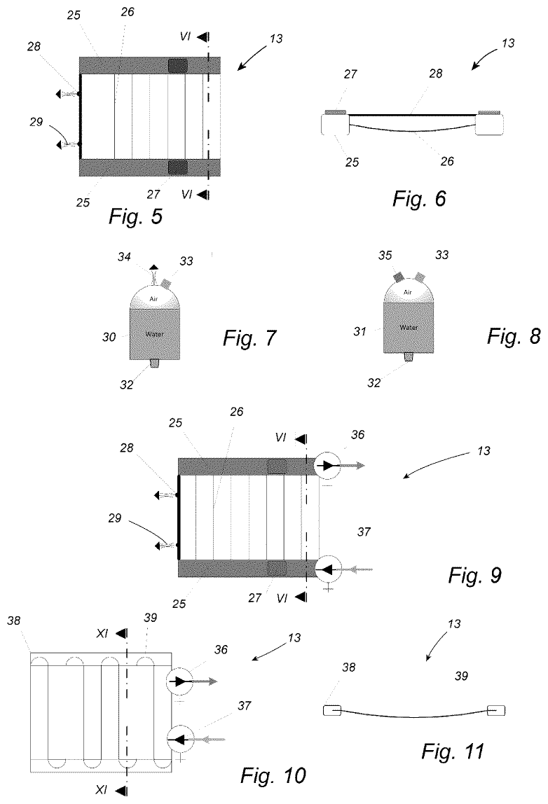

Instead of active cooling, passive cooling of the grill grid 13 can be achieved by using a twin tank grill grid, as illustrated, for example, in FIG. 5 while the active cooling system 16 is not required.

The water tray 19 can be removed from or slid into the cabinet/casing 11 through the openings for water tray 20. The water tray 19 shall be filled ¾ with water, which collects and cools down food residues/grease 18 falling from the grill grid 13. Setting operational parameters, such as power or cooling intensities can be done in the control board 21 section.

FIG. 3 shows a variant of the barbecue system of FIG. 1 in a hot pot application. For hot pot application, a hot pot holder 22 can be put in place of the grill grid 13 to hold a hot pot 23 thus allowing to convert the smokeless barbecue system into a hot pot cooking system.

FIG. 4 shows a variant of the barbecue system of FIG. 1 in a pan-fry application. Similarly, the smokeless barbecue system can easily be transformed into a pan-frying system by using a pan 24 of FIG. 4 instead of the grill grid 13. The pan 24 has centrically symmetric slopes and holes allowing grease 18 to drop down to water tray 24.

Users just need to invest in one smokeless barbecue system for three different applications: barbecue, hot pot, and pan-frying.

Depending on the form of energy employed, mobility and recommendations for use in gastronomic facilities vary.

Table 1 summarizes the various forms of energy, and their recommended areas of employment in different embodiments of the present disclosure.

TABLE 1

| | | | | Carbon | | | Recommended |
|---|---|---|---|---|---|---|---|
| | | | | Monoxide | Governmental | Recommended | for Indoor |
| | | Grill Burner | Mobility - | (CO) | Safety | for Private | Gastronomic |
| Energy Form | Energy Supply | (left & right) | Preferred | Emission | Requirements | Households | Facilities |
| Electricity | Power plant | Infrared | indoors | no | low | yes | yes |
| | Powerful | lamp | (outdoors, if | | | | |
| | battery | | electricity | | | | |
| | | | available) | | | | |
| Natural Gas | City gas | Infrared | indoors | yes | very high | conditionally | no |
| (NG) | | ceramic | | | | | |
| | | burner | | | | | |
| Liquefied | Gas cylinder | Infrared | indoors | yes | very high | conditionally | no |
| Petroleum Gas | Gas tank | ceramic | outdoors | | | | |
| (LPG) | | burner | | | | | |
| Butane Propane | Cartridge | Infrared | indoors | yes | medium to | yes | yes |
| | | ceramic | outdoors | | high | | |
| | | burner | | | | | |
| Hydrogen | Power plant | Infrared | indoors | yes | medium to | yes | yes |
| (green/blue) | Cartridge | ceramic | outdoors | | high | | |
| | | burner | | | | | |
| Charcoal | Common | Rectangular | outdoors | yes | very high | conditionally | no |
| | charcoal | charcoal | | | | | |
| | suppliers | basket | | | | | |

The present disclosure employs both fossil energy carriers and energy carriers converted from renewable energy. Furthermore, electrical energy can be used as heat source. In addition to charcoal, natural gas (NG), liquefied petroleum gas (LPG), and gas from cartridges, being the current common sources of fossil energy, this disclosure also consider hydrogen (green/blue) being the future energy carrier converted from renewable energy. Gas cartridges can be filled with butane & propane or hydrogen. These fossil energy carriers and hydrogen produce carbon monoxide (CO), whereas the utilization of electrical energy is free of CO, making it the most preferred energy option for indoor application of the smokeless barbecue system.

In the following, certain embodiments of the grill grid 13 using water batteries will be described in connection with FIGS. 5 to 11.

Preferred grill grid configurations, and their recommended areas of employment are summarized in Table 2 below.

TABLE 2

| | | | | | | | Recommended |
|---|---|---|---|---|---|---|---|
| | | | | | | | for Indoor |
| | | | Connected | | | | Gastronomic |
| Grill Grid and | | Watter | to Active | | | | Facilities & |
| Water Battery | | Battery | Cooling | Passive | Active | | Private |
| Type | Drawing | Connectable | System* | Cooling | Cooling | Mobility | Households |
| Twin Tank Grill | FIG. 5, 6, | yes | no | yes | no | indoors | yes |
| Grid | | | | | | outdoors | |
| Twin Tank Grill | FIG. 9, 6 | yes | yes | no | yes | indoors | yes |
| Grid With Ports | | | | | | outdoors | |
| Meandering | FIG. 10, 11 | no | yes | no | yes | indoors | yes |
| Grill Grid Pipe | | | | | | outdoors | |
| Water Battery | FIG. 7 | — | no | yes | no | indoors | yes |
| | | | | | | outdoors | |
| Water Battery | FIG. 8 | — | no | yes | no | indoors | yes |
| With | | | | | | outdoors | |
| Compressed Air | | | | | | | |

FIG. 5 shows an embodiment of a passively cooled grill grid according to one embodiment of the present disclosure. FIG. 6 shows a section view of the embodiment of FIG. 5 according to line VI-VI of FIG. 5.

The twin tank grill grid 13 comes in two different preferred types: FIG. 5 outlines the type without ports, and FIG. 9. With ports. Both types can be connected to a water battery as shown, for instance, in FIG. 7, to replenish the twin water tanks 25 with water vaporizing over the course of the barbecue process. Passive and active cooling can be achieved by cooling down a multitude of tubes 26 with water. Passive cooling means that water between the twin water tanks 25 and the tubes 26 are exchanged during the barbecue process. Please note, that no circulation literally occurs between the tubes and the twin water tanks.

FIG. 5 shows the twin tank grill grid for passive cooling. It is self-sufficient in terms of autonomous cooling, as no external forces or equipment are required to cool down the tubes 26 of the grill grid, preventing the barbecue food from being burnt and smoked. The twin water tanks 25 are connected in equidistance by multitude of tubes 26, allowing water being exchanged between the twin water tanks 25 and the tubes 26, resulting in cooling down the water within the tubes 26. The tubes 26 are symmetric, downward sloping tubes to direct grease moving towards the center of the grill grid (V-shape tubes). To prepare the use of the twin tank grill grid 13, the twin water tanks 25 need to be filled with water up to a predefined level. To do so, one of the two caps 27 shall be opened for water inlet. The caps 27 are closed prior to use of the grill grid. During the barbecue process, steams are produced by boiling water inside the tubes 26, which escape into each of the twin water tanks 25. The steams collected in the twin water tanks 25, above water level therein, are discharged through valves or holes 29 distributed evenly on a bigger tube 28 connecting the upper hollow spaces of the twin water tanks 25. The steam discharge has three essential physical effects: first, to ease overpressure within the grill grid; second, to cool down the grill grid; and third, to reduce water volume inside the grill grid. Therefore, after a certain grill time, the water inside the twin tank grill grid is depleted, requiring it to be replaced by another grill grid filled with water, otherwise the depleted grill grid cannot be cooled down resulting in smokes generation.

Alternatively, a water battery 30 or 31, as shown in FIGS. 7 and 8, respectively, can be docked on just one or both twin water tanks 25 by opening the cap 27 and plugging the connector 32 of the water batteries 30 or 31 on the twin water tanks 25. The connector 32 can be provided with an adjustment screw and the water rate can be adjustable.

FIG. 7 outlines the water battery 30 featuring a cap 33 for water inlet/outlet; a valve/hole 34 to equalize air pressure inside and outside the water battery and a connecter 32 with adjustment screw to tune the water drain rate.

FIG. 8 depicts a water battery with compressed air 31. After filling the water battery 31 up to predefined level with water, and closing the cap 33 again, the air within the water battery 31 can be charged with compressed air by an external air compressor via valve 35. The increased air pressure inside the water battery would allow a higher water drain rate at the connecter 32 if required.

FIG. 9 shows an alternative grill grid with connections to an active cooling system. FIG. 9 illustrates the twin tank grill grid with ports for active cooling. Production deviations of the twin tank grill grid and stochastical heating behavior within the tubes can cause impulsive peaks of steam expansions, which in turn lead to harmless implosions inside the twin tank grill grid. Although the implosions are harmless, they cause noises and trigger higher magnitude of steams discharge, creating psychical fear to some users. To solve this problem, the water inside the tubes 26 must be cooled down faster than the time it needs to be transformed into steams caused by constant heat radiated from the grill burner (reference signs 15 in FIGS. 1-4). The solution is to circulate the water inside the tubes 26 so it does not have enough time to be transformed into steams, and to cool down the water before feeding it back to the tubes 26. FIG. 9 shows such a solution: the ports 36, 37 of the grill grid 13 is connected to an active cooling system. The active cooling system cools down the water coming from one twin water tank 25 through the outlet, female port 36, and feeds back the cooled water into the other twin water tank through the inlet, female port 37. This process results in a continuous circulation of cooled water inside the tubes 26. An additional advantage of the active cooling system is that it has a water storage, allowing replenishment of depleted water in the grill grid. Thus, there is no need of using an extra water battery. Moreover, to direct grease and food residues to spread more towards the center of the tubes 26, and fall centrically on the water tray, instead of splashing towards the twin water tanks 25, tubes 26 have symmetric downward slopes, forming a V-shape (see section view of FIG. 6).

FIG. 10 shows yet another alternative grill grid 13 with connections to an active cooling system. FIG. 11 shows a section view of the grill grid of FIG. 10 according to line XI-XI of FIG. 10. Instead of employing the twin tank grill grid with ports, active cooling can be achieved by using a meandering grill grid pipe. FIG. 10 describes a preferred construction of a meandering grill grid pipe for active cooling made from a frame 38 and a meandering pipe 39. Like the twin tank grill grid with ports, it also possesses inlet and outlet ports 37, 36 hooked up to an active cooling system. However, instead of straight tubes, it consists of just one seamless pipe 39 curving in a zigzag shape without interconnections to form a grill grid, with each terminal mounted to the outlet or inlet, female port 36, 37. Unlike the twin tank grill grid with ports, it does not need twin water tanks. Smokelessness and prevention of implosions inside the hollow pipe can be achieved in the same way as described for FIG. 5 and FIG. 9: both, by cooling down the grill grid and circulating the water therein by the active cooling system. In addition, to direct grease and food residues to spread more towards the center of the grill grid, and fall centrically on the water tray, instead of splashing towards the frame 38, the meandering pipe 39 has symmetric downward slopes, forming a V-shape (see section view of FIG. 11).

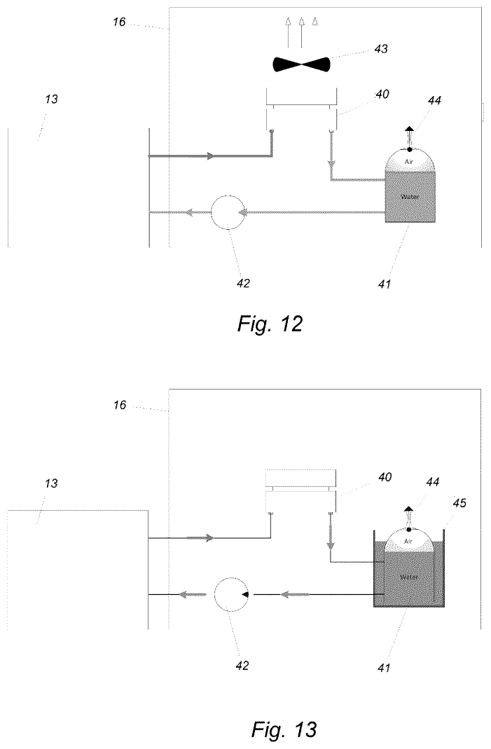

In the following, a detailed description of active cooling systems with hydraulic pump is given with reference to preferred embodiments shown in FIGS. 12 to 14.

Table 3 below summarizes configurations of active cooling system with hydraulic pump, and their recommended areas of employment.

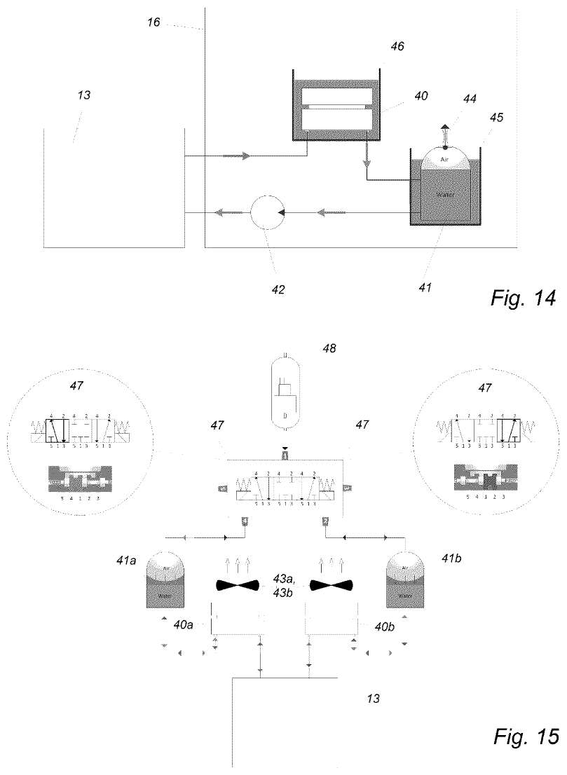

TABLE 3

| Preferred | | | | | | | | | Recommended |
|---|---|---|---|---|---|---|---|---|---|
| Configuration | | | | | | | | | for |
| of Active | | | | | | | Cooling | | Gastronomic |
| Cooling | | Hydraulic | | | Cooling | | Tub for | | Facilities & |
| System With | | Pump | Grill Grid | | Tub for | | Water | | Private |
| Hydraulic Pump | Drawing | Type | Type | Radiator | Radiator | Fan | Storage | Mobility | Households |
| With Fan | FIG. 12 | Hydraulic | Twin Tank | yes | no | yes | no | indoors | yes |
| | | Pump | Grill Grid | | | | | (for | |
| | | (electric, | With Ports | | | | | outdoors, | |
| | | Ram or | Meandering | | | | | see Tab. 4) | |
| | | other) | Grill Pipe | | | | | | |
| Without Fan, | FIG. 13 | Hydraulic | Twin Tank | yes | no | no | yes | indoors | yes |
| with Cooling Tub | | Pump | Grill Grid | | | | | (for | |
| for Water | | (electric, | With Ports | | | | | outdoors, | |
| Storage | | Ram or | Meandering | | | | | see Tab. 4) | |
| | | other) | Grill Pipe | | | | | | |
| Without Fan, | FIG. 14 | Hydraulic | Twin Tank | yes | yes | no | yes | indoors | yes |
| with Cooling Tub | | Pump | Grill Grid | | | | | (for | |
| for Radiator and | | (electric, | With Ports | | | | | outdoors, | |
| for Water | | Ram or | Meandering | | | | | see Tab. 4) | |
| Storage | | other) | Grill Pipe | | | | | | |

Table 4 indicates hydraulic pump configurations, and their recommended areas of employment.

TABLE 4

| Preferred | | | | Recommended for | Recommended for |
|---|---|---|---|---|---|
| Hydraulic | | External | | Private | Gastronomic |
| Pump Type | Drawing | Energy | Mobility | Households | Facilities |
| Electric | FIG. 12, | Electricity | indoors | yes | yes |
| Hydraulic | 13, 14 | | (outdoors, if | | |
| Pump | | | electricity is | | |
| | | | available) | | |
| Hydraulic Ram | FIG. 12, | none | indoors | yes | yes |
| Pump | 13, 14 | | outdoors | | |
| Other | FIG. 12, | Tbd. | indoors | yes | yes |
| Hydraulic | 13, 14 | | (outdoors | | |
| Pump | | | conditionally) | | |

FIG. 12 shows a first embodiment of an active cooling system 16 with hydraulic pump and fan for a grill grid in accordance with the present disclosure. Hot water coming from a grill grid 13 will be fed into the radiator 40, which cools down the water before feeding it into a water storage 41. The hydraulic pump 42 pumps cooled water from the bottom of the water storage 41 back into the grill grid 13 preventing it from smoking during the barbecue process. The fan 43 accelerates the cooling process by ventilating the heat from the radiator. The water storage 41 ensures bubble-free water supply to the grill grid 13 and serves as reservoir for replenishing of depleted water in the grill grid 13. Air bubbles in the water of the water storage 41 will rise to the upper part of it, and exhaust through the air escape valve 44. There are two preferred types of grill grid 13 appropriate for the active cooling system: twin tank grill grid with ports (FIG. 9), and meandering grill grid pipe (FIG. 10).

FIG. 13 outlines an active cooling system with hydraulic pump, without fan, and with cooling tub 45 for water storage 41. Instead of using a fan as featured in FIG. 12, the water storage 41 can be placed in a cooling tub for water storage 45. This also accelerates the cooling process of water before feeding it back to the grill grid 13.

FIG. 14 outlines an active cooling system with hydraulic pump, without fan, and with cooling tub 45 for water storage and cooling tub 46 for radiator. The water storage 41 can be placed in a cooling tub for water storage 45, and the radiator 40 in the cooling tub for radiator 46.

This intensifies the acceleration of the cooling process of water before feeding it back to the grill grid 13.

In the following, a detailed description of active cooling systems with air pressure is given in connection with embodiments shown in FIGS. 15 to 20.

Instead of using electrical energy or a hydraulic pump, air pressure is a natural driving force to circulate water through the active cooling system and the grill grid. The subsequent explanations elaborate the basic mechanism and several preferred configurations of this concept.

Table 5 summarizes various configurations of active cooling system with air pressure, and their recommended areas of employment.

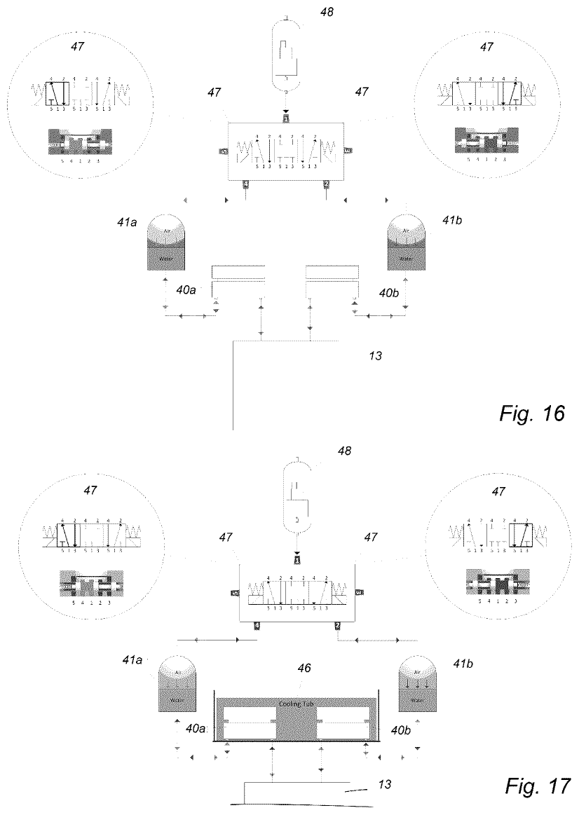

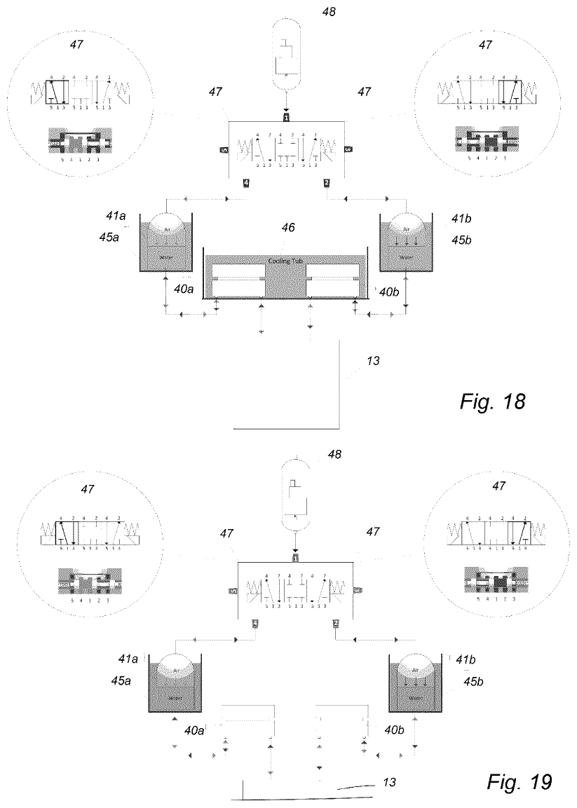

TABLE 5

| Preferred | | | | | | | | Recommended |
|---|---|---|---|---|---|---|---|---|
| Configuration | | | | | | | | for |
| of Active | | | | | | Cooling | | Gastronomic |
| Cooling System | | | | Cooling | | Tub for | | Facilities & |
| With Air | | | | Tub for | | Water | | Private |
| Pressure | Drawing | Grill Grid Type | Radiator | Radiator | Fan | Container | Mobility | Households |
| With Fan | FIG. 15 | Twin Tank Grill | yes | no | yes | no | indoors | yes |
| | | Grid With Ports | | | | | outdoors | |
| | | Meandering Grill | | | | | | |
| | | Pipe | | | | | | |
| Without Fan | FIG. 16 | Twin Tank Grill | yes | no | no | no | indoors | yes |
| | | Grid With Ports | | | | | outdoors | |
| | | Meandering Grill | | | | | | |
| | | Pipe | | | | | | |
| With Cooling | FIG. 17 | Twin Tank Grill | no | yes | no | no | indoors | yes |
| Tub for | | Grid With Ports | | | | | outdoors | |
| Radiators only | | Meandering Grill | | | | | | |
| | | Pipe | | | | | | |
| With Cooling | FIG. 18 | Twin Tank Grill | no | yes | no | yes | indoors | yes |
| Tub for | | Grid With Ports | | | | | outdoors | |
| Radiators and | | Meandering Grill | | | | | | |
| for Water | | Pipe | | | | | | |
| Containers | | | | | | | | |
| With Cooling | FIG. 19 | Twin Tank Grill | no | no | no | yes | indoors | yes |
| Tub for | | Grid With Ports | | | | | outdoors | |
| Water | | Meandering Grill | | | | | | |
| Containers | | Pipe | | | | | | |
| only | | | | | | | | |

FIG. 15 illustrates the basic function of an active cooling system with air pressure, with fan. At any given time, the water between the first water container 41a and the second one 41b flows in just one direction. Let's assume that the water flows from left water container 41a to right water container 41b, with left radiator 40a, grill grid 13, and right radiator 40b in between. In this stage, the spool valve 47 channels compressed air from the air compressor 48 to the left water container 41a, causing air overpressure in the upper part of the same. The air overpressure then drives water out of the left water container 41a. As soon as the water level in the right water container 41b reaches a predefined water threshold, the spool valve 47 will be activated to channel compressed air in the opposite direction, pressing the water in the right water container 41b through the right radiator 40b, through the grill grid 13, and then through the left radiator 40a back into the left water container 41a. Thereafter, once the water level in the left water container 41a reaches a predefined water threshold, the spool valve 47 will be activated again to change compressed air to flow in the opposite direction. This mechanism alternately circulate water in the active cooling system and in the grill grid 13, thereby cooling down the grill grid 13 to prevent it from smoking during the barbecue process. The fans 43a, 43b accelerate the cooling process of the radiators by ventilating heat away from the same.

The spool valve 47 operates in 3 different modes. First, in neutral (inactivated) mode, all ports of it are shut, and compressed air from the air compressor 48 is shut as well. Second, if the spool valve 47 is activated on the left side, the compressed air coming via port 1 from the air compressor 48 will be channeled to port 4 and will be fed into the left water container 41a, concurrently cutting off the compressed air supply for the right water container 41b. As a result, the water level in the right water container 41b continuously rises. Third, the right side of the spool valve 47 is activated as soon as the predefined water threshold in the right water container 41b is reached, and navigates compressed air from port 1 to port 2, feeding the right water container with compressed air, concurrently cutting off the compressed air supply for the left water container 41a, causing the water level in the same to rise. The spool valve 47 comes in two variants of activators: either electric or mechanical.

If the left water container 41a is supplied with compressed air through port 1 and port 4, water level inside the right water container 41b continuously rises, pressing out the air above water level of the same from port 2 to port 3. Vice versa, as long as the right water container 41b is supplied with compressed air through port 1 and port 2, the air above water level of the left water container 41a will be exhausted from port 4 to port 5.

FIG. 16 illustrates an active cooling system with air pressure similar to FIG. 15, but without fan. Leaving out cooling fan is possible if the radiators are efficient enough to cool down the water for a proper grill process without smoke.

FIG. 17 outlines an active cooling system with air pressure like FIG. 16, but with a cooling tub 46 for the left and right radiator 40a, 40b. This is recommended if the radiators require additional cooling support to cool down the water for a proper grill process without smoke.

FIG. 18 depicts an active cooling system with air pressure similar to FIG. 17, but with both a cooling tub 46 for the left and right radiators 40a, 40b and a cooling tub 45a, 45b for each water container 41a, 41b. This is desirable if the radiators require even more cooling support to cool down the water for a proper grill process without smoke.

FIG. 19 shows an active cooling system with air pressure like FIG. 18, but with a cooling tub 45a, 45b for each water container 41a, 41b only, if this is sufficient to cool down the water for a proper grill process without smoke.

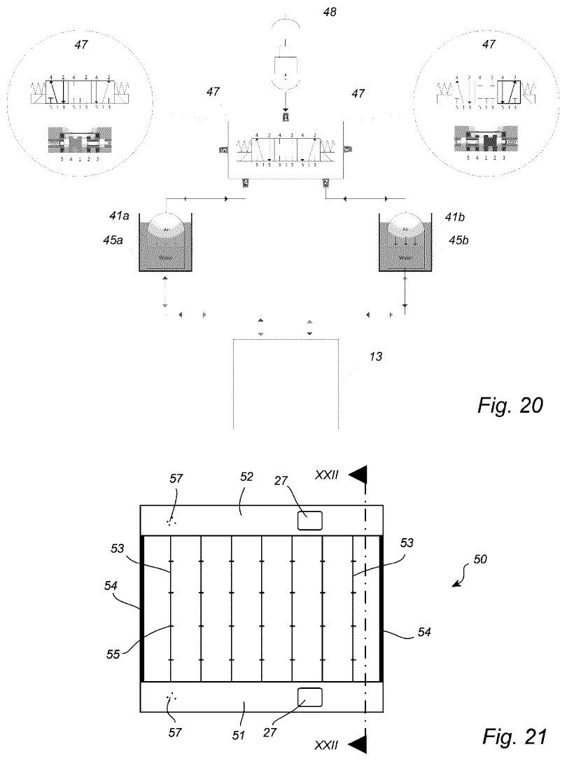

FIG. 20 describes an active cooling system with air pressure similar to FIG. 19, but without radiators, and with a cooling tub 45a, 45b for each water container 41a, 41b only, if this is sufficient to cool down the water for a proper grill process without smoke.

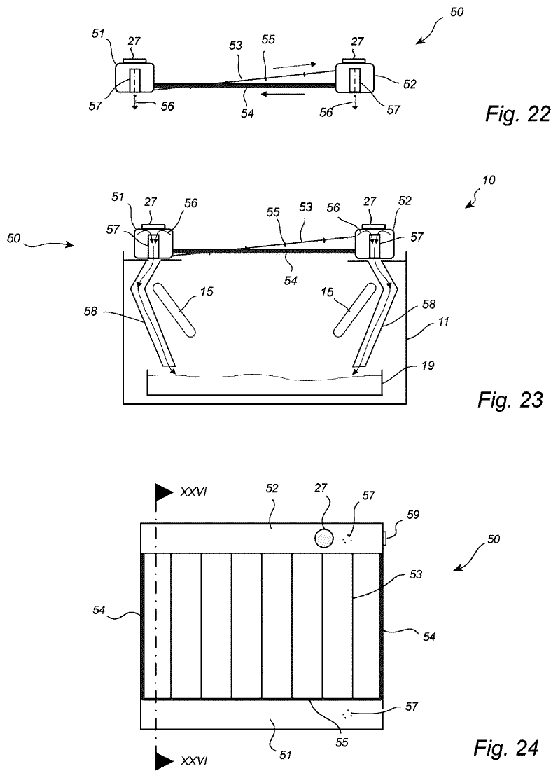

A further embodiment of the smokeless barbecue system according to the present disclosure is described in connection with FIGS. 21 to 23. Elements which have already been described in connection with other embodiments above are denoted by the same reference signs. The barbecue system of this embodiment employs a self-sufficient cooling using a self-circulating gravity grill grid allowing active cooling.

As can be taken from FIG. 21, the grill grid 50 comprises a bottom water tank 51 and a top water tank 52 which are floated with water. Water tanks 51, 52 are interconnected by several first tubes 53 which have a positive slope, i.e. the first tubes rise from bottom water tank 51 to top water tank 52. In the embodiment depicted in FIGS. 21-23, the first tubes 53 have an essentially equal slope forming a slightly inclined support plane for food. Further, the bottom water tank 51 and the top water tank 52 are interconnected by two second tubes 54 which extend essentially horizontally, i.e. exhibit essentially zero slope. In the depicted embodiment, the first inclined tubes have a smaller inner diameter than the second horizontal tubes. Usually, this would also imply that the outer diameter of the first tubes 53 is smaller than the outer diameter of the second tubes so that, with respect to each other, the first tubes can be denoted “smaller tubes” and the second tubes can be denoted “bigger tubes”.

In use, grilled food is placed on the smaller first tubes 53 for barbecuing. Grease stoppers 55, which can be configured as rings surrounding the smaller first tubes 53 at certain intervals, prevent grease from falling downwards and spilling into grill burner 15 which are usually arranged on the side of the bottom water tank 51 and/or the top water tank 52 as indicated in FIG. 23. Accordingly, generation of smoke and possible damage of the grill burner over time by dripping grease is avoided.

During use, water inside the smaller first tubes 53 is heated up by the operation of the grill burners 15 resulting in a lower water density and thus becoming lighter than the water outside of the smaller first tubes 53. The water temperature within the bottom and top water tanks 51, 52 is cooler than the water temperature within the smaller first tubes 53. Accordingly, water within the smaller first tubes 53 will gain a higher buoyancy allowing water in the smaller first tubes 53 to flow against the force of gravity upwards into the top water tank 52 which, in turn, draws cooler water from the bottom water tank 51 into the smaller tubes 53 where it is recurrently heated up by the grill burners.

The heated water flow from the smaller first tubes 53 into the top water tank 52 causes the water level in the top water tank 52 to rise to a higher level than the water level in the bottom water tank 51. Due to the force of gravity, the water levels in both water tanks 51, 52 tends to be equalized by water circulating from the top water tank 52 to the bottom water tank 51 through the two bigger second tubes 54.

The continued process induces a self-circulation of water within the grill grid, whereby cooling down the smaller first tubes 53, thus preventing the burning of grill food and the corresponding generation of smoke. Accordingly, a smokeless barbecue system using a grill grid according to the embodiments of FIGS. 21-23 represents a self-driven cooled grill grid without requiring application of external forces or application of any external power sources. Self-sufficient cooling derives merely from establishing a self-circulation of water within the grill grid relying merely on the physical properties of water during heating and the application of the gravitational force acting on the system.

Upon heating of water in the smaller first tubes 53, steam 56 may be generated. As shown in FIG. 23, steam 56 is collected in the bottom and top water tanks 51, 52 above the respective water levels and can be discharged through steam tubes 57 and team ducting 58. Eventually, steam 56 condenses within the steam ducting and the resulting condensed water falls down into the water drain 19. The steam discharge has three essential physical effects: firstly, it will ease overpressure within the grill grid, secondly, it will help to further cool down the grill grid and thirdly, it will reduce the water volume circulating inside the grill grid. Therefore, after a certain operation time, the water inside the grill grid will get more and more depleted and its cooling functionality diminishes. Accordingly, the grill grid may be provided with a recharge opening (such as the caps 27 indicated in FIG. 21) allowing fresh water to be introduced into the grill. Handling of a hot grill grid for filling up water may, however, be associated with certain safety risks. Therefore, according to another option, the self-sufficient cooling grill grid is removably arranged within the barbecue system allowing it to be replaced by another grill grid filled with water. The proper timing for re-filling the grill grid or replacing the grill grid can easily be detected by the onset of smoke generation. More preferably however, to avoid any generation of smoke, the appliance can be provided with a timer which is set to indicate a typical operating time of the grill grid until water re-fill or grid replacement is required. In addition or alternatively, the bottom water tank can be provided with a water level indicator.

Since the self-circulating grill grid according to the present embodiment does not require any external power source, it represents the most ecofriendly version of the cooling systems described in the present application.

FIGS. 24 to 27 show another embodiment of the disclosure of a self-circulating grill grid allowing active cooling.

As can be taken from FIG. 24, the grill grid 50 comprises a bottom water tank 51 and a top water tank 52 which are floated with water. Water tanks 51, 52 are interconnected by several first tubes 53 which have a positive slope, i.e. the first tubes rise from bottom water tank 51 to top water tank 52. In the embodiment depicted in FIGS. 24-27, the first tubes 53 have an essentially equal slope forming a slightly inclined support plane for food. Further, the bottom water tank 51 and the top water tank 52 are interconnected by two second tubes 54 which extend essentially horizontally, i.e. exhibit essentially zero slope. In the depicted embodiment, the first inclined tubes have a smaller inner diameter than the second horizontal tubes. Usually, this would also imply that the outer diameter of the first tubes 53 is smaller than the outer diameter of the second tubes so that, with respect to each other, the first tubes can be denoted “smaller tubes” and the second tubes can be denoted “bigger tubes”. In use, grilled food is placed on the smaller first tubes 53 for barbecuing. Grease stopper 55, which projects along the inner lower edge of the bottom water tank 51, prevents grease 18 from falling downwards and spilling into grill burner 15, which are usually arranged on the side of the bottom water tank 51 and/or the top water tank 52 as indicated in FIG. 27. Accordingly, generation of smoke and possible damage of the grill burner over time by dripping grease is avoided. During use, water inside the smaller first tubes 53 is heated up by the operation of the grill burners 15 resulting in a lower water density and thus becoming lighter than the water outside of the smaller first tubes 53. The water temperature within the bottom and top water tanks 51, 52 is cooler than the water temperature within the smaller first tubes 53. Accordingly, water within the smaller first tubes 53 will gain a higher buoyancy allowing water in the smaller first tubes 53 to flow against the force of gravity upwards into the top water tank 52 which, in turn, draws cooler water from the bottom water tank 51 into the smaller tubes 53 where it is recurrently heated up by the grill burners. The heated water flow from the smaller first tubes 53 into the top water tank 52 causes the water level in the top water tank 52 to rise to a higher level than the water level in the bottom water tank 51. Due to the force of gravity, the water levels in both water tanks 51, 52 tends to be equalized by water circulating from the top water tank 52 to the bottom water tank 51 through the two bigger second tubes 54. The continued process induces a self-circulation of water within the grill grid, whereby cooling down the smaller first tubes 53, thus preventing the burning of grill food and the corresponding generation of smoke. Accordingly, a smokeless barbecue system using a grill grid according to the embodiments of FIGS. 24-27 represents a self-driven cooled grill grid without requiring application of external forces or application of any external power sources. Self-sufficient cooling derives merely from establishing a self-circulation of water within the grill grid relying merely on the physical properties of water during heating and the application of the gravitational force acting on the system. Upon heating of water in the smaller first tubes 53, steam 56 may be generated. As shown in FIG. 27, steam 56 is collected in the bottom and top water tanks 51, 52 above the respective water levels and can be discharged through steam tubes 57 and team ducting 58. Eventually, steam 56 condenses within the steam ducting and the resulting condensed water falls down into the water tray 19. The steam discharge has three essential physical effects: firstly, it will ease overpressure within the grill grid; secondly, it will help to further cool down the grill grid; and thirdly, it will reduce the water volume circulating inside the grill grid. Therefore, after a certain operation time, the water inside the grill grid will get more and more depleted, and its cooling functionality diminishes. Accordingly, the grill grid may be provided with a recharge opening (such as the cap 27 indicated in FIG. 24) allowing fresh water to be introduced into the grill. Handling of a hot grill grid for filling up water may, however, be associated with certain safety risks.

Therefore, according to another option, the self-sufficient cooling grill grid is removably arranged within the barbecue system, allowing it to be replaced by another grill grid filled with water. The proper timing for re-filling the grill grid or replacing the grill grid can easily be detected by the onset of smoke generation. More preferably however, to avoid any generation of smoke, the appliance can be provided with a timer which is set to indicate a typical operating time of the grill grid until water re-fill or grid replacement is required.

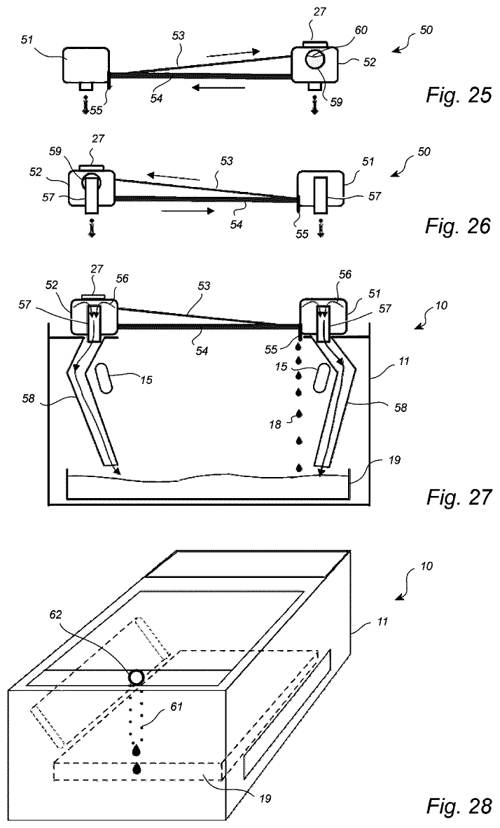

In addition, or alternatively, the top water tank can be provided with a visible water level indicator window 59 as indicated in FIG. 25. User can see the water level 60 within that window, and shall refill the grill grid, or replace the grill grid if the water level sinks below certain threshold. Since the self-circulating grill grid, according to the present embodiment, does not require any external power source, it represents the most ecofriendly version of the cooling systems described in the present application.

FIG. 28 shows a perspective view of still another embodiment of a smokeless barbecue system in accordance with the present disclosure having a refill system for the water tray in a similar view as the embodiment of FIG. 1.

The water within the water tray 19 is exposed to heat and depletes over the course of the barbecuing process. FIG. 28 illustrates a water tray refill tube 61, starting from the top surface of the grill, and terminates just above the water tray. Without interrupting the barbecue process, user can insert a funnel into the opening 62 of the refill tube 61, and pour water into the funnel for refill of the water tray 19.

### LIST OF REFERENCE SIGNS

10 cooking appliance, barbecue system
11 casing
12 upper opening of casing
13 grill grid
14 heating assembly
15 heating elements, grill burners
16 cooling system
17 food
18 food residues, grease
19 water tray
20 opening for water tray
21 control board
22 pot holder
23 hot pot
24 frying pan
25 twin water tank
26 tubes
27 caps of twin water tanks
28 big tube
29 valves, holes in big tube
30 water battery
31 water battery with compressed air
32 connector
33 cap for water inlet/outlet
34 valve/hole
35 valve for charging with compressed air
36 outlet port
37 inlet port
38 frame
39 meandering pipe
40, 40a, 40b radiator
41, 41a, 41b water storage, water container
42 hydraulic pump
43, 43a, 43b fan
44 air escape valve
45, 45a, 45b cooling tub for water storage
46 cooling tub for radiator
47 spool valve
48 air compressor
50 self-circulating grill grid
51 bottom water tank
52 top water tank
53 smaller first tubes
54 bigger second tubes
55 grease stopper
56 steam
57 steam tube
58 steam ducting
59 water level indicator window
60 water level
61 water refill tube
62 opening of refill tube

1-21. (canceled)

22. A cooking appliance comprising:
a casing having an upper opening;
a grill grid arranged in said upper opening of said casing;
a heating assembly comprising at least one heating element arranged within said casing, said heating element being connectable to an energy source; and
a cooling system comprising a source of cooling fluid for cooling said grill grid, wherein:
said grill grid comprises a hollow tube assembly connectable to said cooling system, said hollow tube assembly comprising essentially parallel hollow tubes extending between a first water tank arranged on one side said grill grid and a second water tank arranged on an opposite side of said grill grid, said essentially parallel hollow tubes being configured as first tubes which rise from said first (or bottom) water tank to said second (or top) water tank, and at least two second tubes extend horizontally between said first (or bottom) water tank and said second (or top) water tank.

23. The cooking appliance of claim 22, wherein said heating assembly comprises two heating elements arranged laterally beneath said grill grid.

24. The cooking appliance of claim 23, wherein said heating elements comprise electric heaters connectable to a re-chargeable battery housed within said casing and/or to an external power grid.

25. The cooking appliance of claim 24, wherein said electric heaters comprise fiber carbon heaters.

26. The cooking appliance of claim 23, wherein said heating elements comprise gas heaters connectable to a gas supply, said gas supply being selected from a built-in gas cartridge removable housed within said casing, an external gas tank or to fixedly installed gas line.

27. The cooking appliance of claim 22, wherein said hollow tube assembly comprises a meandering hollow tube.

28. The cooking appliance of claim 22, wherein said source of cooling fluid comprises a water battery or water storage arranged in a cooling circuit.

29. The cooking appliance of claim 28, wherein said cooling circuit comprises a radiator.

30. The cooking appliance of claim 28, wherein said water battery or water storage is pressurizable.

31. The cooking appliance of claim 28, wherein said cooling circuit comprises a feed pump selected from electric pumps or hydraulic pumps, especially hydraulic RAM-pumps or hydraulic pumps operated by pressurized air.

32. The cooking appliance of claim 22, wherein said first tubes have a smaller inner diameter than said second tubes.

33. The cooking appliance of claim 22, wherein said first tubes comprise grease stoppers at their outer circumference.

34. The cooking appliance of claim 22, wherein a grease stopper is arranged at a bottom edge of said first (or bottom) water tank.

35. The cooking appliance of claim 22, wherein said first and second tanks comprise steam outlet.

36. The cooking appliance of claim 35, wherein said steam outlets comprise steam tubes, said steam tubes being connected to downwardly extending steam ductings.

37. The cooking appliance of claim 22, further comprising a water tray arranged beneath said grill grid within said casing.

38. The cooking appliance of claim 22, wherein said grill grid is removable.

39. A set comprising a cooking appliance, a hot pot holder, and a pan tray, said cooking appliance comprising:
a casing having an upper opening;
a grill grid arranged in said upper opening of said casing;
a heating assembly comprising at least one heating element arranged within said casing, said heating element being connectable to an energy source; and
a cooling system comprising a source of cooling fluid for cooling said grill grid,
wherein:
said grill grid comprises a hollow tube assembly connectable to said cooling system, said hollow tube assembly comprising essentially parallel hollow tubes extending between a first water tank arranged on one side said grill grid and a second water tank arranged on an opposite side of said grill grid, said essentially parallel hollow tubes being configured as first tubes which rise from said first (or bottom) water tank to said second (or top) water tank, and at least two second tubes extend horizontally between said first (or bottom) water tank and said second (or top) water tank, and
said grill grid, said hot pot holder, and said pan tray are exchangeably arrangeable in said upper opening of said casing.
